(19) United States
(12) Patent Application Publication
(10) Pub. No.: US 2026/0358145 A1
(43) Pub. Date: Nov. 12, 2026

(54) DIAL INPUT DEVICE

(71) Applicant: MERRY ELECTRONICS (SHENZHEN) CO., LTD., GUANGDONG (CN)

(72) Inventors: Ching-Hsiung LIN, Taichung City (TW); Yung Tsung HSU, Taichung City (TW)

(21) Appl. No.: 19/329,578

(22) Filed: Sep. 16, 2025

(30) Foreign Application Priority Data
May 12, 2025 (TW) 114117758

(51) Int. Cl. G01D 5/20; G01D 7/00

(52) U.S. Cl. CPC G01D 5/2006; G01D 7/00

(57) ABSTRACT

A dial input device includes a base, a rotatable component, a rotation indicator object and a rotation detector. The rotatable component is rotatably disposed on the base. The rotation indicator object, which is at least partially formed of metal, is disposed on the rotatable component and can rotate with the rotatable component. The rotation detector is disposed on the base and includes a plurality of sensing coils arranged along a circumferential direction. The rotation detector is configured to utilize the sensing coils to detect a change of magnetic field caused by movement of the rotation indicator object. The rotation detector is further configured to provide a signal in accordance with the change of magnetic field. The signal is indicative of a rotation direction of the rotatable component.

### RELATED APPLICATIONS

This application claims priority to Taiwan Application Serial Number 114117758, filed May 12, 2025, the disclosure of which is incorporated herein by reference in its entirety.

### BACKGROUND

### Technical Field

The present disclosure relates to a dial input device.

### Description of Related Art

Some electronic devices are equipped with dials capable of infinite rotation for volume adjustment or other purposes. Currently, a more common way to create a dial with infinite rotation capability is to use rotary encoder. However, using rotary encoder imposes restrictions on the structure of the dial. For example, when rotary encoder is used, there is no feasible way to create a dial with an immovable central part and a rotatable outer ring.

### SUMMARY

In view of the foregoing, one of the objects of the present disclosure is to provide an improved dial input device to resolve the problems described above.

In accordance with an embodiment of the present disclosure, a dial input device includes a base, a rotatable component, at least one rotation indicator object and a rotation detector. The rotatable component is rotatably disposed on the base. The rotation indicator object is disposed on the rotatable component and is configured to rotate with the rotatable component. The rotation indicator object is at least partially formed of metal. The rotation detector is disposed on the base and includes a plurality of sensing coils arranged along a circumferential direction. The rotation detector is configured to utilize the sensing coils to detect a change of magnetic field caused by movement of the rotation indicator object. The rotation detector is further configured to provide a signal in accordance with the change of magnetic field. The signal is indicative of a rotation direction of the rotatable component.

In one or more embodiments of the present disclosure, the rotatable component includes a non-metallic shell which is annular and has a bottom surface. The rotation detector is positioned to face the bottom surface of the non-metallic shell. The rotation indicator object includes at least one metal sheet attached to the bottom surface of the non-metallic shell.

In one or more embodiments of the present disclosure, the rotatable component includes a metallic shell. The metallic shell includes an annular main body and at least one bent structure. The annular main body has a central opening. The bent structure is connected to the annular main body and is bent towards the central opening. The bent structure functions as the rotation indicator object.

In one or more embodiments of the present disclosure, the dial input device further includes at least one rotation assisting component. The rotation assisting component is disposed on the rotatable component and is in sliding or rolling contact with the base. The rotation assisting component is at least partially formed of metal and functions as the rotation indicator object.

In one or more embodiments of the present disclosure, the at least one rotation indicator object is plural, and the rotation indicator objects are arranged circumferentially on the rotatable component and are spaced apart from one another.

In one or more embodiments of the present disclosure, the rotation indicator object includes a metal conductor which is not a permanent magnet.

In one or more embodiments of the present disclosure, the rotatable component includes at least one rounded projection slidably engaging the base.

In one or more embodiments of the present disclosure, the at least one rounded projection and the at least one rotation indicator object are both plural, and the rounded projections and the rotation indicator objects are arranged in an interleaved manner.

In one or more embodiments of the present disclosure, the dial input device further includes a shim disposed between the rounded projection of the rotatable component and the base.

In one or more embodiments of the present disclosure, the base includes a central portion and an outer ring portion arranged along a perimeter of the central portion. The rotatable component is annular and is arranged around the central portion of the base. The rotatable component has an inner surface and a bottom surface. The inner surface faces the central portion of the base, and the bottom surface faces the outer ring portion of the base. The rounded projection is disposed on the bottom surface of the rotatable component. The dial input device further includes at least one rotation assisting component disposed on the inner surface of the rotatable component and in sliding or rolling contact with the base.

In one or more embodiments of the present disclosure, the central portion of the base has at least one recess receiving at least a portion of the at least one rotation assisting component.

In one or more embodiments of the present disclosure, the rotation assisting component includes at least one of a rolling wheel, a spring-loaded ball plunger, or a rigid structure with a curved surface.

In accordance with an embodiment of the present disclosure, a dial input device includes a base, a rotatable component, a plurality of rotation indicator objects and a rotation detector. The rotatable component is rotatably disposed on the base. The rotation indicator objects are disposed on the rotatable component and are configured to rotate with the rotatable component. Each of the rotation indicator objects is at least partially formed of metal. The rotation detector is disposed on the base and includes a plurality of sensing coils arranged along a circumferential direction. The rotation detector is configured to utilize the sensing coils to detect a change of magnetic field caused by movement of the rotation indicator objects. The rotation detector is further configured to provide a signal in accordance with the change of magnetic field. The signal is indicative of a rotation direction and a rotation angle of the rotatable component.

In one or more embodiments of the present disclosure, the rotatable component includes a non-metallic shell which is annular and has a bottom surface. The rotation detector is positioned to face the bottom surface of the non-metallic shell. The rotation indicator objects include a plurality of metal sheets attached to the bottom surface of the non-metallic shell.

In one or more embodiments of the present disclosure, the rotatable component includes a metallic shell. The metallic shell includes an annular main body and a plurality of bent structures. The annular main body has a central opening. The bent structures are connected to the annular main body and are bent towards the central opening. The bent structures function as the rotation indicator objects.

In one or more embodiments of the present disclosure, the rotatable component includes a plurality of rounded projections slidably engaging the base.

In one or more embodiments of the present disclosure, the rounded projections and the rotation indicator objects are arranged in an interleaved manner.

In one or more embodiments of the present disclosure, each of the rotation indicator objects includes a metal conductor which is not a permanent magnet.

In one or more embodiments of the present disclosure, the rotation indicator objects are arranged circumferentially and equidistantly.

In one or more embodiments of the present disclosure, the rotation angle of the rotatable component indicated by the signal is expressed as a step count. A quantity of the rotation indicator objects corresponds to a number of step changes when the rotatable component makes one turn.

In sum, in the dial input device of the present disclosure, an annular rotatable component operable by the user is provided on the outer side of the dial input device, and the annular rotatable component is capable of unlimited rotation. The dial input device converts a rotation operation performed by the user into an input signal, which is indicative of the direction of rotation of the annular rotatable component. The dial input device detects the direction of rotation of the annular rotatable component in the following way: the annular rotatable component is provided with at least one rotation indicator object formed of conductive metal material; the dial input device further includes a rotation detector, and the rotation detector includes a plurality of sensing coils arranged along a circumferential direction; when the position of the rotation indicator object changes as a result of the rotation of the annular rotatable component, the rotation detector utilizes the sensing coils to detect a change of magnetic field caused by the change of position of the rotation indicator object and provides the input signal in accordance with the change of magnetic field.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates an axonometric view of an electronic device in accordance with an embodiment of the present disclosure;

FIG. 2 illustrates a partial cross-sectional view of the electronic device shown in FIG. 1;

FIG. 3 illustrates an exploded view of the dial input device of the electronic device shown in FIG. 1;

FIG. 4 illustrates a bottom view of some components of the dial input device shown in FIG. 3;

FIG. 5 illustrates a partial cross-sectional view of an electronic device in accordance with another embodiment of the present disclosure;

FIG. 6 illustrates an exploded view of some components of the dial input device shown in FIG. 5;

FIG. 7 illustrates a partial cross-sectional view of an electronic device in accordance with another embodiment of the present disclosure;

FIG. 8 illustrates an enlarged view of some components of the dial input device shown in FIG. 7;

FIG. 9 illustrates a partial cross-sectional view of an electronic device in accordance with another embodiment of the present disclosure; and

FIG. 10 illustrates an enlarged view of some components of the dial input device shown in FIG. 9.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

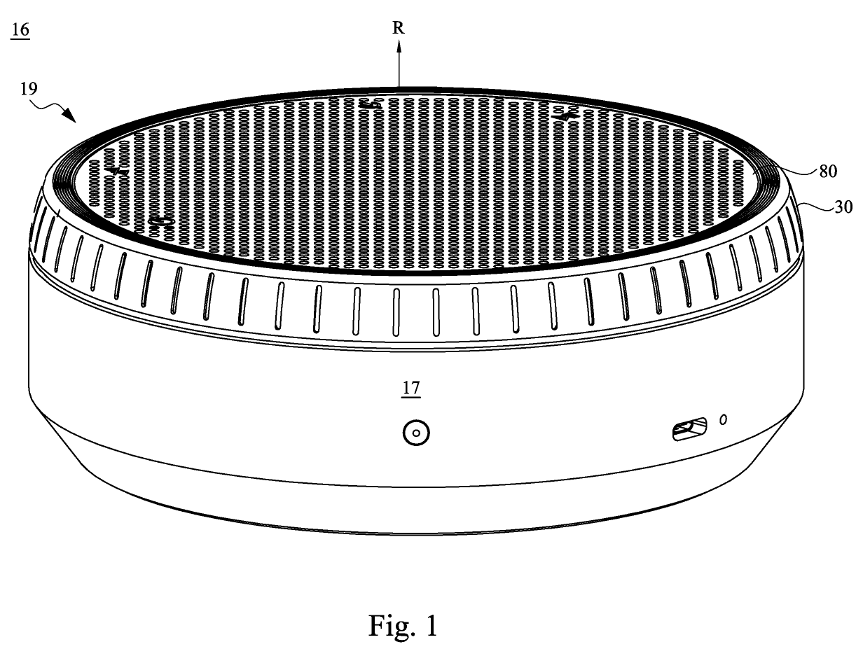

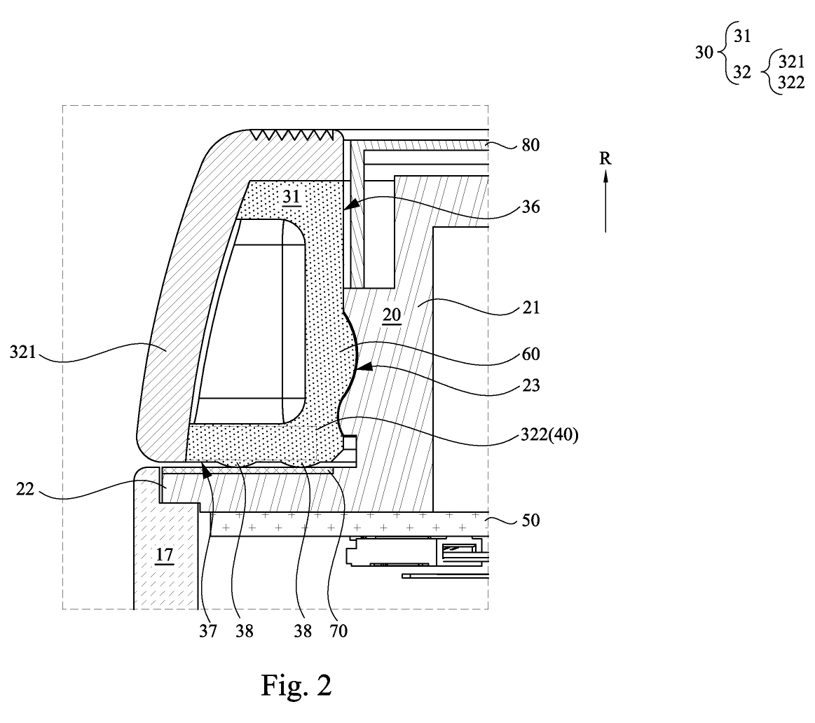

Reference is made to FIG. 1. FIG. 1 illustrates an axonometric view of an electronic device 16 in accordance with an embodiment of the present disclosure. The electronic device 16 includes a housing 17 and a dial input device 19 disposed on the housing 17. The dial input device 19 can be operated by a user to perform operations such as volume adjustment or image zooming. The electronic device 16 can be a headphone, a speaker, a computer or the like. In other words, the dial input device 19 can be integrated into a host device such as a headphone, a speaker or a computer. Alternatively, the electronic device 16 can be a peripheral device which can be connected to a host device such as a headphone, a speaker or a computer via a cable (e.g., USB cable) or via wireless communication (e.g., Bluetooth). The dial input device 19 includes a base (e.g., the base 20 shown in FIG. 2) and a rotatable component 30 disposed on the base. The base is stationary. The rotatable component 30 is a ring-shaped component arranged along a perimeter of the base and operable by the user. The rotatable component 30 can rotate freely on the base, with no restrictions on its angle of rotation or number of revolutions.

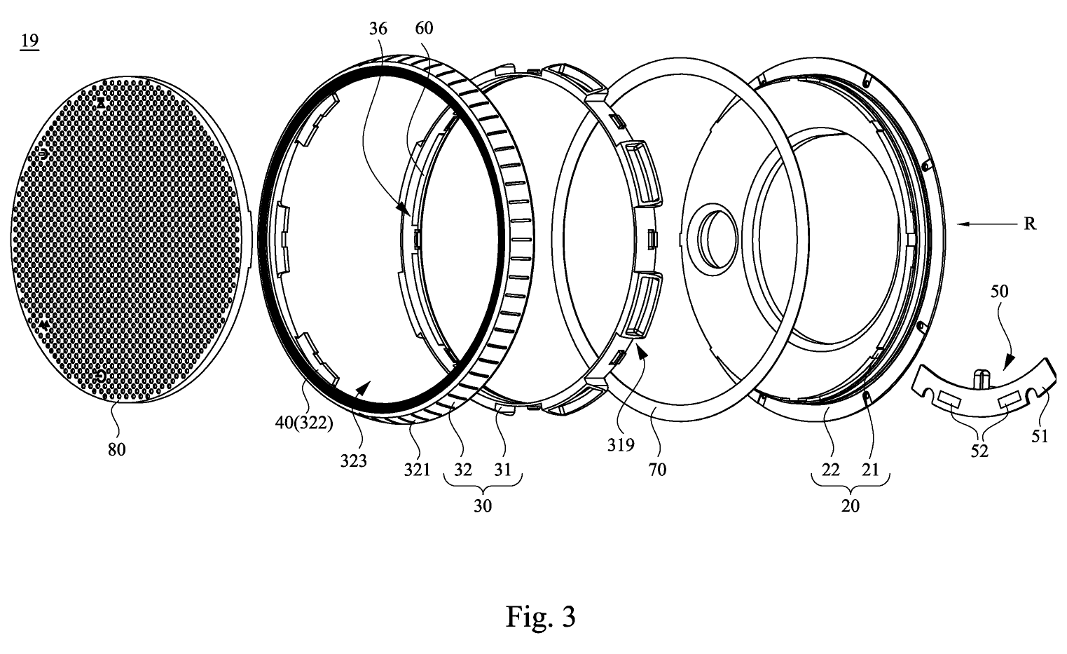

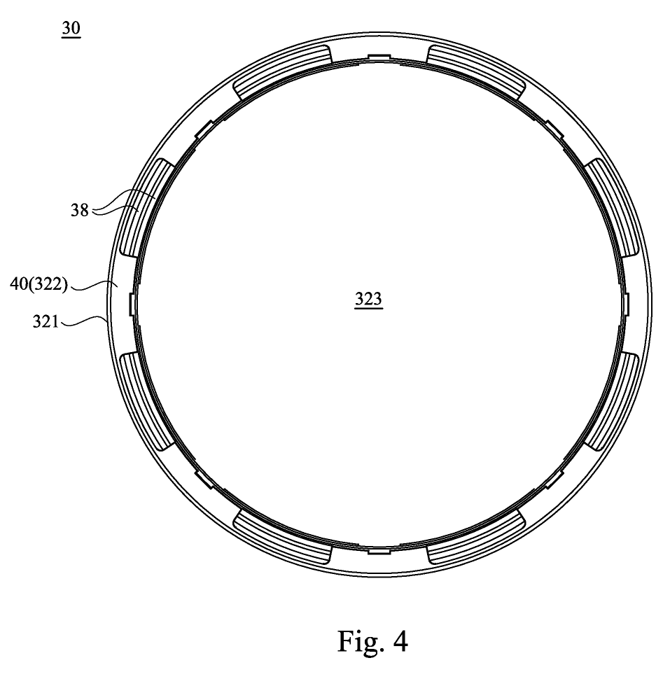

Reference is made to FIGS. 2-4. FIG. 2 illustrates a partial cross-sectional view of the electronic device 16 shown in FIG. 1, FIG. 3 illustrates an exploded view of the dial input device 19 of the electronic device 16 shown in FIGS. 1, and 4 illustrates a bottom view of some components of the dial input device 19 shown in FIG. 3. As mentioned above, the dial input device 19 includes the base 20 and the rotatable component 30. The base 20 can be affixed to the housing 17, and the rotatable component 30 is rotatably disposed on the base 20. In the present embodiment, the base 20 includes a central portion 21 and an outer ring portion 22. The outer ring portion 22 is arranged along a perimeter of the central portion 21. In other words, the central portion 21 is disposed at the center of the outer ring portion 22, and the central portion 21 projects from the outer ring portion 22 in an axial direction R (e.g., a direction along which a rotation axis of the rotatable component 30 extends). The rotatable component 30 is annular and is arranged around the central portion 21 of the base 20. In the present embodiment, the rotatable component 30 includes an inner shell 31 and an outer shell 32, both of which are annular. The outer shell 32 is arranged around the inner shell 31. In other words, the inner shell 31 is located between the outer shell 32 and the central portion 21 of the base 20. The inner shell 31 and the outer shell 32 can be combined by adhesive bonding, snap fitting or other suitable means.

As shown in FIGS. 2-4, the dial input device 19 further includes at least one rotation indicator object 40 and a rotation detector 50. The rotation indicator object 40 is disposed on the rotatable component 30 and is configured to rotate with the rotatable component 30. The rotation indicator object 40 is at least partially formed of metal (e.g., copper, iron, or any other suitable metal conductor that is not a permanent magnet). The rotation detector 50 is disposed on the base 20. The rotation detector 50 can include a circuit board 51 and a plurality of sensing coils 52 disposed on the circuit board 51 and arranged along a circumferential direction. The rotation detector 50 shown in the drawings includes two sensing coils 52. However, the present disclosure is not limited thereto. The number of sensing coils 52 may be increased to three or more as needed. During operation, when the position of the rotation indicator object 40 changes as a result of the rotation of the rotatable component 30, the rotation detector 50 utilizes the sensing coils 52 to detect a change of magnetic field caused by the change of position (i.e., movement) of the rotation indicator object 40 and provides one or more input signals in accordance with the change of magnetic field. The input signals are indicative of a rotation direction of the rotatable component 30. For example, when the rotation indicator object 40 moves from an upper side of a first sensing coil of the plurality of sensing coils 52 to an upper side of a second sensing coil of the plurality of sensing coils 52, the rotation detector 50 can detect a first change of magnetic field. On the contrary, when the rotation indicator object 40 moves from the upper side of the second sensing coil to the upper side of the first sensing coil, the rotation detector 50 can detect a second change of magnetic field different from the first change of magnetic field. In this way, the different rotation directions (clockwise or counterclockwise) of the rotatable component 30 can be differentiated. The rotation detector 50 can be an inductive sensor, in which the sensing coils 52 are supplied with electric current and produce changing magnetic fields. When the rotation indicator object 40 including conductive metal material enters the magnetic fields produced by the sensing coils 52, eddy current is induced on the rotation indicator object 40, and the eddy current produces an opposing magnetic field that causes the inductance of the sensing coils 52 to change.

When a control component (not depicted in the drawings; can be a controller or a processor, for example) of the electronic device 16 receives the input signal provided by the rotation detector 50, the control component of the electronic device 16 can make a determination about whether the rotatable component 30 is rotating clockwise or counterclockwise and adjust a state of the electronic device 16 accordingly. For example, the control component of the electronic device 16 can increase the volume of the electronic device 16 from a first value to a second value greater than the first value when the control component of the electronic device 16 makes a determination that the rotatable component 30 is rotating clockwise. On the other hand, the control component of the electronic device 16 can decrease the volume of the electronic device 16 from the first value to a third value less than the first value when the control component of the electronic device 16 makes a determination that the rotatable component 30 is rotating counterclockwise.

As shown in FIGS. 2-4, in some embodiments, the dial input device 19 includes a plurality of rotation indicator objects 40 arranged circumferentially on the rotatable component 30 and are spaced apart from one another. By this arrangement, the input signal provided by the rotation detector 50 can further indicate a rotation angle of the rotatable component 30. In some embodiments, the rotation angle of the rotatable component 30 indicated by the input signal can have discrete values. For example, when the dial input device 19 includes eight rotation indicator objects 40 as depicted in the drawings, the rotation angle of the rotatable component 30 indicated by the input signal can be integer multiples of 45 degrees (360 degrees divided by eight). The rotation angle of the rotatable component 30 indicated by the input signal can also be expressed as a step count. For example, zero degrees correspond to zero steps, 45 degrees correspond to one step, 90 degrees correspond to two steps, and so on. The quantity of the rotation indicator object 40 can correspond to the number of step changes when the rotatable component 30 makes one turn. For example, eight rotation indicator objects 40 correspond to eight step changes when the rotatable component 30 makes one turn. When the actual rotation angle of the rotatable component 30 is not an integer multiple of 45 degrees, the rotation angle of the rotatable component 30 can be rounded (e.g., rounded to the nearest integer multiple of 45 degrees).

As shown in FIGS. 2-4, in some embodiments, the rotation indicator object 40 and the rotation detector 50 are positioned to face two opposite surfaces (e.g., upper surface and lower surface) of the outer ring portion 22 of the base 20, respectively. The base 20 can be formed of non-conductive material (e.g., plastic) to avoid interfering with the rotation detector 50’s ability to detect rotation of the rotatable component 30. In the present embodiment, the outer shell 32 of the rotatable component 30 is a metallic shell. The outer shell 32 includes an annular main body 321 and at least one bent structure 322. The annular main body 321 has a central opening 323. The bent structure 322 is connected to the annular main body 321 and is bent towards the central opening 323. The bent structure 322 functions as the rotation indicator object 40. The inner shell 31 of the rotatable component 30, on the other hand, includes non-conductive material. The inner shell 31 has at least one recess 319. When the inner shell 31 is combined with the outer shell 32, each bent structure 322 mates with a corresponding recess 319.

As shown in FIGS. 2-4, in some embodiments, the rotatable component 30 has an inner surface 36 and a bottom surface 37. The inner surface 36 faces the central portion 21 of the base 20, and the bottom surface 37 faces the outer ring portion 22 of the base 20. The rotatable component 30 further includes at least one rounded projection 38 disposed on the bottom surface 37 of the rotatable component 30. The rounded projection 38 has a curved surface and can slidably engage the outer ring portion 22 of the base 20. The rounded projection 38 can be an elongated structure extending along the circumferential direction, but is not limited thereto. In addition, the dial input device 19 can further include at least one rotation assisting component 60 disposed on the inner surface 36 of the rotatable component 30 and in sliding contact with the central portion 21 of the base 20. In the present embodiment, the rotation assisting component 60 is a rigid structure with a curved surface. The rotation assisting component 60 is affixed to the rotatable component 30 (e.g., the rotation assisting component 60 and the inner shell 31 of the rotatable component 30 can be integrally formed) and projects from the inner surface 36 of the rotatable component 30. The rotation assisting component 60 can be an elongated structure extending in the circumferential direction, but is not limited thereto. By this arrangement, the rotatable component 30 can stably rotate on the base 20.

As shown in FIGS. 2-4, in some embodiments, the at least one rounded projection 38 and the at least one rotation indicator object 40 of the dial input device 19 are both plural, and the rounded projections 38 and the rotation indicator objects 40 are arranged circumferentially and are arranged in an interleaved manner. In other words, each rounded projection 38 is disposed between two rotation indicator objects 40, and each rotation indicator object 40 is disposed between two sets of rounded projections 38. For example, each set of rounded projections 38 can include two rounded projections 38 arranged in a radial direction. In other embodiments, each set of rounded projections 38 can include more than two or fewer than two rounded projections 38. The rounded projections 38 can be arranged equidistantly. The rotation indicator objects 40 can be arranged equidistantly as well.

As shown in FIGS. 2-4, in some embodiments, the dial input device 19 further includes a shim 70 disposed between the rounded projection 38 of the rotatable component 30 and the outer ring portion 22 of the base 20. With the shim 70, the rounded projection 38 can be prevented from directly rubbing against the base 20 when the rotatable component 30 is rotating. The shim 70 can include Polytetrafluoroethylene (Teflon), Polyoxymethylene (POM), Polypropylene (PP), other suitable materials or any combination thereof. The shim 70 can be designed to be abrasion-resistant to prolong the lifespan of the dial input device 19.

As shown in FIGS. 2-4, in some embodiments, the central portion 21 of the base 20 has at least one recess 23. The recess 23 is disposed on a lateral surface of the central portion 21 of the base 20, and the recess 23 extends circumferentially for a full circle. The recess 23 can receive at least a portion of the rotation assisting component 60. In other words, at least a portion of the rotation assisting component 60 extends into the recess 23. The rotation assisting component 60 of the present embodiment is a protruding structure with a curved surface. The recess 23 and the rotation assisting component 60 can have complementary shapes to prevent upward detachment of the rotatable component 30 from the base 20.

As shown in FIGS. 2-4, in some embodiments, the dial input device 19 further includes a mesh component 80 fixedly mounted on the base 20 and covering the central portion 21 of the base 20. The rotatable component 30 can be arranged around the mesh component 80. The mesh component 80 may include metal material, but is not limited thereto.

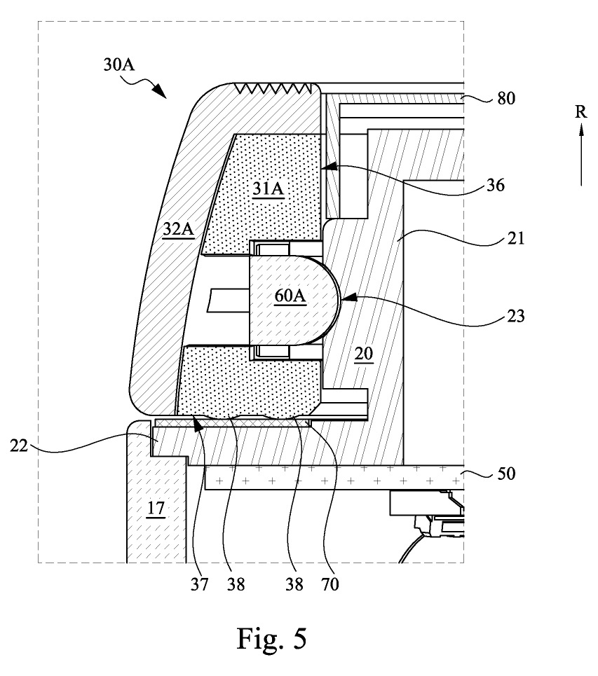

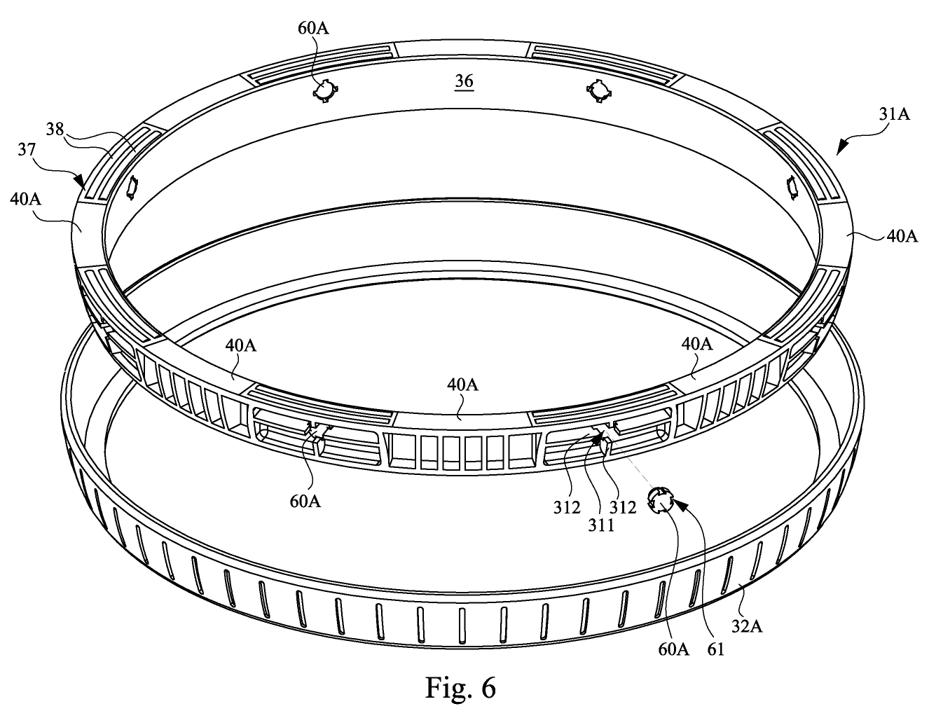

Reference is made to FIGS. 5 and 6. FIG. 5 illustrates a partial cross-sectional view of an electronic device in accordance with another embodiment of the present disclosure, and FIG. 6 illustrates an exploded view of some components of the dial input device shown in FIG. 5. The present embodiment differs from the embodiment described above in that: the rotatable component 30A of the present embodiment includes a non-metallic shell (e.g., the entire rotatable component 30A, including the inner shell 31A and the outer shell 32A, is formed of non-metallic material and is electrically non-conductive); the rotation indicator object 40A includes at least one metal sheet attached to the bottom surface 37 of the rotatable component 30A (more specifically, the metal sheet is attached to the bottom surface of the inner shell 31A); and the rotation detector 50 is positioned to face the bottom surface 37 of the rotatable component 30A and is configured to detect a change of magnetic field caused by movement of the metal sheet. In some embodiments, the dial input device includes a plurality of metal sheets arranged circumferentially on the bottom surface 37 of the rotatable component 30A and spaced apart from one another. In some embodiments, the rounded projections 38 of the rotatable component 30A are arranged into multiple disconnected sections on the bottom surface 37 of the rotatable component 30A. A planar region is provided between two adjacent sets of rounded projections 38, and the metal sheet is disposed in the planar region.

As shown in FIGS. 5 and 6, the present embodiment further differs from the embodiment described above in that the rotation assisting component 60A of the present disclosure is a ball. The ball is affixed to the inner shell 31A of the rotatable component 30A and has a curved surface on a side facing the base 20, and the curved surface abuts (e.g., in sliding contact with) the base 20. The other side of the ball can have other shapes, i.e., the ball does not necessarily have to be a sphere. The ball can be formed of POM or other non-metallic materials to avoid interfering with the rotation detector 50’s ability to detect rotation of the rotatable component 30A. The dial input device can include a plurality of balls arranged circumferentially on the inner surface 36 of the rotatable component 30A and surrounding the central portion 21 of the base 20. In some embodiments, the ball has a plurality of notches 61 on its lateral surface. The inner shell 31A has a through hole 311 and a plurality of rib structures 312 around the through hole 311. During the process of assembling the dial input device, the notches 61 of the ball can first be lined up with the rib structures 312 such that the ball can be inserted into the through hole 311. Subsequently, the ball can be rotated by a certain angle such that the notches 61 and the rib structures 312 become misaligned, and as a result, the ball can be held in position. In some embodiments, the outer shell 32A can cover the ball, the through hole 311 and the rib structures 312 from the outside to prevent them from being exposed.

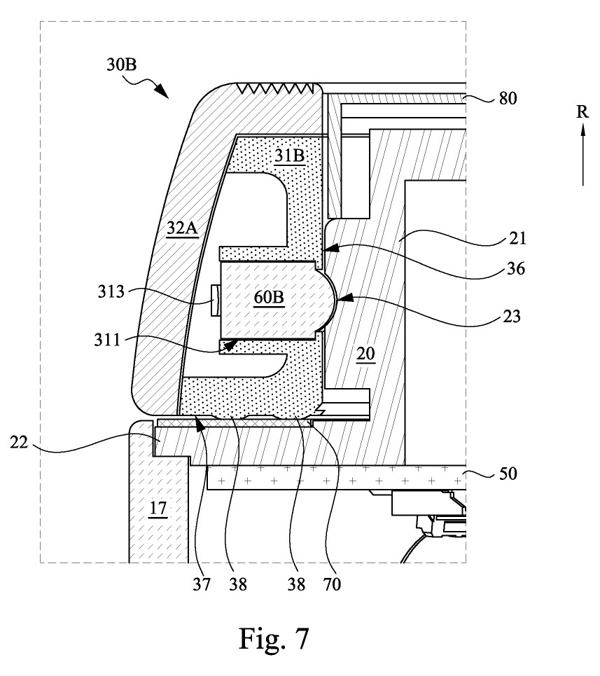

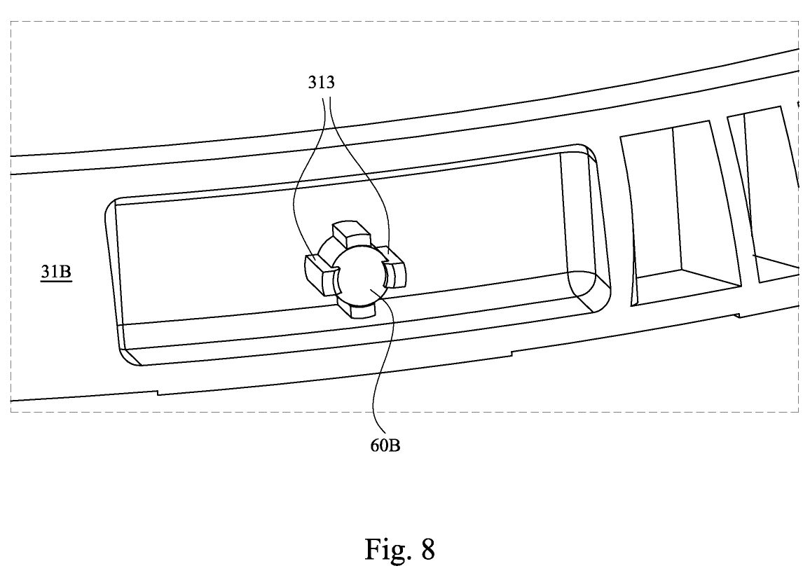

Reference is made to FIGS. 7 and 8. FIG. 7 illustrates a partial cross-sectional view of an electronic device in accordance with another embodiment of the present disclosure, and FIG. 8 illustrates an enlarged view of some components of the dial input device shown in FIG. 7. The present embodiment differs from the embodiment shown in FIGS. 5 and 6 in that the rotation assisting component 60B of the present embodiment is a spring-loaded ball plunger. The spring-loaded ball plunger is disposed on the inner shell 31B of the rotatable component 30B and is in rolling contact with the base 20. The spring-loaded ball plunger can include a main body and a ball rotatably disposed on the main body, in which the ball faces and abuts (e.g., in rolling contact with) the base 20. The spring-loaded ball plunger can be formed of POM or other non-metallic materials to avoid interfering with the rotation detector 50’s ability to detect rotation of the rotatable component 30B. The dial input device can include a plurality of spring-loaded ball plungers arranged circumferentially on the inner surface 36 of the rotatable component 30B and surrounding the central portion 21 of the base 20. In some embodiments, the inner shell 31B has a through hole 311 and a plurality of hooks 313 around the through hole 311. The spring-loaded ball plunger can be inserted in the through hole 311. The spring-loaded ball plunger engages the hooks 313 and is thus held in position by the hooks 313. In some embodiments, the outer shell 32A can cover the spring-loaded ball plunger, the through hole 311 and the hooks 313 from the outside to prevent them from being exposed.

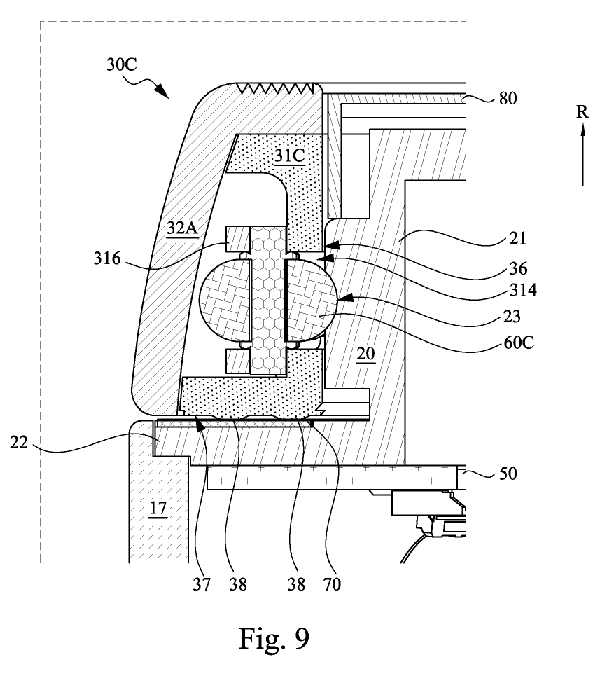

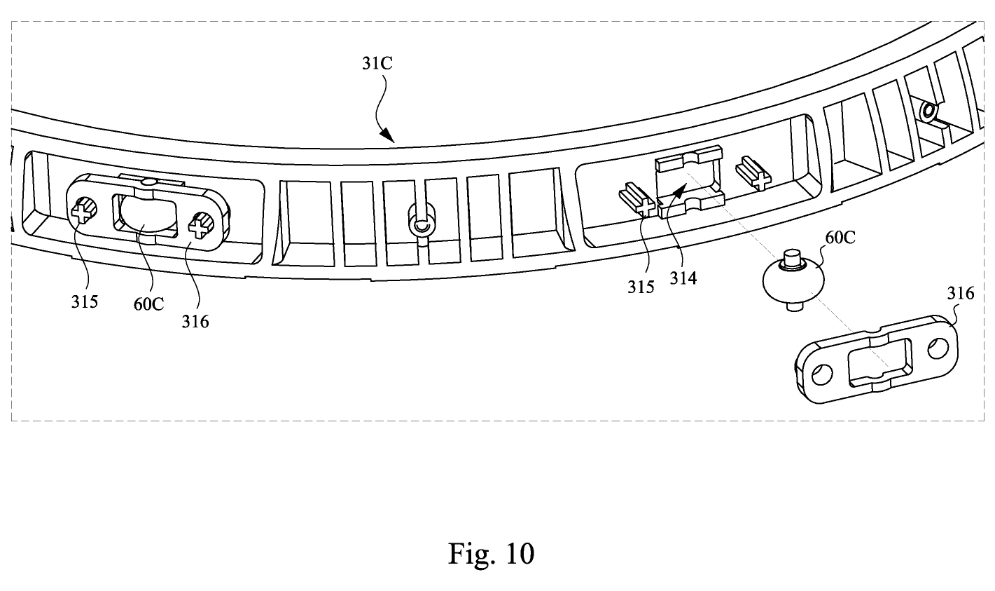

Reference is made to FIGS. 9 and 10. FIG. 9 illustrates a partial cross-sectional view of an electronic device in accordance with another embodiment of the present disclosure, and FIG. 10 illustrates an enlarged view of some components of the dial input device shown in FIG. 9. The present embodiment differs from the embodiment shown in FIGS. 5 and 6 in that the rotation assisting component 60C of the present embodiment is a rolling wheel. The rolling wheel is disposed on the inner shell 31C of the rotatable component 30C and is in rolling contact with the base 20. The rolling wheel can include a shaft and a wheel rotatably disposed on the shaft and abutting (e.g., being in rolling contact with) the base 20. The rolling wheel can be formed of POM or other non-metallic materials to avoid interfering with the rotation detector 50’s ability to detect rotation of the rotatable component 30C. The dial input device can include a plurality of rolling wheels arranged circumferentially on the inner surface 36 of the rotatable component 30C and surrounding the central portion 21 of the base 20. In some embodiments, the inner shell 31C has an opening 314 and at least one fixing post 315 positioned next to the opening 314. The rolling wheel is disposed in the opening 314. A fixing piece 316 is provided on an outer side of the rolling wheel, and the fixing piece 316 can be used to affix the rolling wheel to the inner shell 31C. The fixing piece 316 can have at least one through hole through which the fixing post 315 can be inserted. Moreover, in some embodiments, the fixing post 315 can be hot-melted to firmly secure the fixing piece 316. In some embodiments, the outer shell 32A can cover the rolling wheel, the opening 314, the fixing post 315 and the fixing piece 316 from the outside to prevent them from being exposed.

Furthermore, in some embodiments, the ball, the spring-loaded ball plunger or the rolling wheel can be at least partially formed of metal (for example, the ball can be a metal ball, the spring-loaded ball plunger can include a metal ball or a metal shell, or the shaft of the rolling wheel can be formed of metal). In such embodiments, the ball, the spring-loaded ball plunger or the rolling wheel can function as the rotation indicator object, and the metal sheet mentioned above (i.e., the rotation indicator object 40A) can be omitted. Such an arrangement also enables detecting rotation of the rotatable component 30A, 30B or 30C.

In sum, in the dial input device of the present disclosure, an annular rotatable component operable by the user is provided on the outer side of the dial input device, and the annular rotatable component is capable of unlimited rotation. The dial input device converts a rotation operation performed by the user into an input signal, which is indicative of the direction of rotation of the annular rotatable component. The dial input device detects the direction of rotation of the annular rotatable component in the following way: the annular rotatable component is provided with at least one rotation indicator object formed of conductive metal material; the dial input device further includes a rotation detector, and the rotation detector includes a plurality of sensing coils arranged along a circumferential direction; when the position of the rotation indicator object changes as a result of the rotation of the annular rotatable component, the rotation detector utilizes the sensing coils to detect a change of magnetic field caused by the change of position of the rotation indicator object and provides the input signal in accordance with the change of magnetic field.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A dial input device, comprising:
a base;
a rotatable component rotatably disposed on the base;
at least one rotation indicator object disposed on the rotatable component and configured to rotate with the rotatable component, wherein the at least one rotation indicator object is at least partially formed of metal; and
a rotation detector disposed on the base and comprising a plurality of sensing coils arranged along a circumferential direction, wherein the rotation detector is configured to utilize the sensing coils to detect a change of magnetic field caused by movement of the at least one rotation indicator object, the rotation detector is further configured to provide a signal in accordance with the change of magnetic field, and the signal is indicative of a rotation direction of the rotatable component.

2. The dial input device of claim 1, wherein the rotatable component comprises a non-metallic shell, the non-metallic shell is annular and has a bottom surface, the rotation detector is positioned to face the bottom surface of the non-metallic shell, and the at least one rotation indicator object comprises at least one metal sheet attached to the bottom surface of the non-metallic shell.

3. The dial input device of claim 1, wherein the rotatable component comprises a metallic shell, the metallic shell comprises an annular main body and at least one bent structure, the annular main body has a central opening, the at least one bent structure is connected to the annular main body and is bent towards the central opening, and the at least one bent structure functions as the at least one rotation indicator object.

4. The dial input device of claim 1, further comprising at least one rotation assisting component, wherein the at least one rotation assisting component is disposed on the rotatable component and is in sliding or rolling contact with the base, wherein the at least one rotation assisting component is at least partially formed of metal and functions as the at least one rotation indicator object.

5. The dial input device of claim 1, wherein the at least one rotation indicator object is plural, and the rotation indicator objects are arranged circumferentially on the rotatable component and are spaced apart from one another.

6. The dial input device of claim 1, wherein the at least one rotation indicator object comprises a metal conductor which is not a permanent magnet.

7. The dial input device of claim 1, wherein the rotatable component comprises at least one rounded projection slidably engaging the base.

8. The dial input device of claim 7, wherein the at least one rounded projection and the at least one rotation indicator object are both plural, and the rounded projections and the rotation indicator objects are arranged in an interleaved manner.

9. The dial input device of claim 7, further comprising a shim disposed between the at least one rounded projection of the rotatable component and the base.

10. The dial input device of claim 7, wherein the base comprises a central portion and an outer ring portion, the outer ring portion is arranged along a perimeter of the central portion, the rotatable component is annular and is arranged around the central portion of the base, the rotatable component has an inner surface and a bottom surface, the inner surface faces the central portion of the base, the bottom surface faces the outer ring portion of the base, the at least one rounded projection is disposed on the bottom surface of the rotatable component, and the dial input device further comprises at least one rotation assisting component disposed on the inner surface of the rotatable component and in sliding or rolling contact with the base.

11. The dial input device of claim 10, wherein the central portion of the base has at least one recess receiving at least a portion of the at least one rotation assisting component.

12. The dial input device of claim 10, wherein the at least one rotation assisting component comprises at least one of a rolling wheel, a spring-loaded ball plunger, or a rigid structure with a curved surface.

13. A dial input device, comprising:
a base;
a rotatable component rotatably disposed on the base;
a plurality of rotation indicator objects disposed on the rotatable component and configured to rotate with the rotatable component, wherein each of the rotation indicator objects is at least partially formed of metal; and
a rotation detector disposed on the base and comprising a plurality of sensing coils arranged along a circumferential direction, wherein the rotation detector is configured to utilize the sensing coils to detect a change of magnetic field caused by movement of the rotation indicator objects, the rotation detector is further configured to provide a signal in accordance with the change of magnetic field, and the signal is indicative of a rotation direction and a rotation angle of the rotatable component.

14. The dial input device of claim 13, wherein the rotatable component comprises a non-metallic shell, the non-metallic shell is annular and has a bottom surface, the rotation detector is positioned to face the bottom surface of the non-metallic shell, and the rotation indicator objects comprise a plurality of metal sheets attached to the bottom surface of the non-metallic shell.

15. The dial input device of claim 13, wherein the rotatable component comprises a metallic shell, the metallic shell comprises an annular main body and a plurality of bent structures, the annular main body has a central opening, the bent structures are connected to the annular main body and are bent towards the central opening, and the bent structures function as the rotation indicator objects.

16. The dial input device of claim 13, wherein the rotatable component comprises a plurality of rounded projections slidably engaging the base.

17. The dial input device of claim 16, wherein the rounded projections and the rotation indicator objects are arranged in an interleaved manner.

18. The dial input device of claim 13, wherein each of the rotation indicator objects comprises a metal conductor which is not a permanent magnet.

19. The dial input device of claim 13, wherein the rotation indicator objects are arranged circumferentially and equidistantly.

20. The dial input device of claim 13, wherein the rotation angle of the rotatable component indicated by the signal is expressed as a step count, and a quantity of the rotation indicator objects corresponds to a number of step changes when the rotatable component makes one turn.
